(19) United States
(12) Patent Application Publication
(10) Pub. No.: US 2025/0178073 A1
(43) Pub. Date: Jun. 5, 2025

(54) METHOD FOR LAYERED CONSTRUCTION OF BODIES COMPRISING REFRACTORY MOLDING BASE MATERIAL AND RESOLS, THREE-DIMENSIONAL BODIES PRODUCED USING THIS METHOD, AND A BINDER FOR THREE-DIMENSIONALLY CONSTRUCTING BODIES

(71) Applicant: ASK Chemicals GmbH, Hilden (DE)

(72) Inventors: Dennis Bartels, Dorsten (DE); Thomas Krey, Dusseldorf (DE); Arkadius Kaminski, Mettmann (DE)

(21) Appl. No.: 18/973,809

(22) Filed: Dec. 9, 2024

Related U.S. Application Data
(62) Division of application No. 17/787,789, filed on Jun. 21, 2022, now abandoned.

(30) Foreign Application Priority Data
Dec. 20, 2019 (DE) 102019135605.9

(51) Int. Cl. B22C 1/22; B29C 64/165; B33Y 70/10; C08G 8/24

(52) U.S. Cl. CPC B22C 1/2253; B29C 64/165; B33Y 70/10; C08G 8/24

(57) ABSTRACT

The object of the invention is a method for the layered construction of bodies comprising refractory molding base material and resol resins as binders having, in addition to phenol, ortho- and/or para-substituted phenols as monomer structural elements and three-dimensional bodies produced according to this method, and a binder for 3-dimensionally constructing bodies, in particular molds and cores for the metal casting.

### CROSS-REFERENCE TO RELATED APPLICATIONS

This application is a divisional of U.S. application Ser. No. 17/787,789 filed Jun. 21, 2022, which is a national stage application of PCT/DE2020/101080 filed Dec. 18, 2020 which claims foreign priority to DE Application No. 102019135605.9 filed Dec. 20, 2019.

### FIELD

The invention relates to a method for the layered construction of bodies comprising refractory molding base material and resol resins as binders having ortho- and/or para-substituted phenols as monomer structural elements and three-dimensional bodies produced according to this method, and a binder for 3-dimensionally constructing bodies, in particular molds and cores for the metal casting.

### PRIOR ART

Various methods for producing three-dimensional bodies by means of layered construction are known under the name Rapid Prototyping. An advantage of these methods is the option to also produce complex bodies consisting of one piece comprising undercuts and hollow spaces. Using conventional methods, these bodies would have to be joined from several, individually manufactured parts. A further advantage is that the methods are highly automated and that the bodies can be produced in a computer-controlled manner directly from the CAD data without molding tools.

Methods for the layered production of molded bodies are known in a large variety of designs. According to them, loose grains of a suitable molding base material, e.g. quartz sand, of which the three-dimensional body is to be constructed, are applied in layers and are either provided with a binder, whereby a curing agent is then applied selectively layer by layer, or the binder itself is applied selectively to the respective layer, e.g. in each case analogously to the mode of operation of an ink jet printer by means of a thin jet or a bundle of thin jets. The curing can take place in layers, because, e.g., the molding base material is provided with a corresponding curing agent, or once all of the layers, which are necessary for the production of the three-dimensional body, are completed. According to this design, the curing reaction can be triggered, for example, by flooding the entire component with a gaseous curing agent or thermally.

EP 3137246 B1 discloses a method for the layered construction of bodies comprising refractory molding base material and resols. Alkaline resol resins, which are cured during the method by means of an ester, which was applied in layers together with the molding base material, are applied selectively via a printing head.

Resols or resol resins, respectively, are phenolic plastics and belong to the class of the phenolic formaldehyde resins. They are produced by means of condensation of a hydroxy aromatic and of an aldehyde, in particular formaldehyde, in the presence of alkaline catalysts. For the production of the alkaline resol resins, formaldehyde and phenol are typically used as monomers and are subjected to a polycondensation reaction. Due to the formaldehyde quantities, which are used hyperstoichiometrically for the most part (e.g. up to 2.5:1), ether groups are also formed in addition to methyl groups for linking purposes.

It is known to the person of skill in the art that in addition to phenol, alkyl phenols, such as, e.g., xylenols or cresols, can also be used as monomer structural elements for the production of resols. However, resols in the form of aqueous alkaline solutions as binders for the production of foundry molds and cores are not usually used with cresols as additional monomer structural element, because they have a disadvantageous effect on price and odor.

### OBJECT OF THE INVENTION

It has been shown that when using phenol, the problem arises that the viscosity of the alkaline resol resin rises strongly over time and the printability of the binder thus deteriorates over time. An increased viscosity in particular leads to a decrease of the resol resin throughput through the printing head to the point of the failure of the printing head. The problem furthermore arises that the reactivity of the resol resin increases over time. The increase of the reactivity leads to a dropping stability level of bound casting molds. The increase of the reactivity manifests itself in the shortening of the gel time, among others. An increased reactivity and a rise of the viscosity have a negative effect on the uniformity of the printing process and deteriorate the stability of the resol resin over time during the printing process.

It is the objective of the present invention to provide a more storage-stable resol resin, the viscosity of which remains more stable over time, exhibits a smaller drop of the gel time, and thus ensures the printability of the binder consisting of the resol resin over a longer period of time. The binder is to furthermore effect a sufficient stability level of bound casting molds.

### SUMMARY OF THE INVENTION

The object is solved by means of the method for the layered construction of bodies comprising the features of claim 1 or the binder according to claim 22, respectively, advantageous further developments are subject matter of the dependent patent claims or will be described below.

The method for the layered construction of bodies comprises at least the following steps:
a) bringing together at least one refractory molding base material and at least one ester for obtaining an ester-impregnated molding material mixture,
b) spreading a thin layer with a layer thickness of 1 to 6, preferably 1 to 5, and particularly preferably 1 to 3 grains of the ester-impregnated molding material mixture,
c) imprinting selected regions of the thin layer with a binder comprising an alkaline resol resin for curing the regions,
d) multiple repetition of the steps b) and c) for the completion of an at least partially cured three-dimensional body,
   wherein the alkaline resol resin can be obtained from the conversion of formaldehyde with at least phenol and at least ortho- and/or para-substituted phenol, wherein the substituent (in each case) is an aliphatic, branched or unbranched, saturated or unsaturated hydrocarbon radical with 1 to 15 C atoms, in particular 1 to 4 C atoms, and the molar ratio of at least ortho- and/or para-substituted phenols (A) to phenol (B) is from 1:1.5 to 1:15 (A:B).

The binder for 3-dimensionally constructing molds and cores for the metal casting comprises (in particular consists of) at least one alkaline resol resin, which can be obtained from the conversion of at least:
a. phenol; and
b. at least phenol, which bears at least one substituent in ortho- and/or para-position, preferably one substituent, wherein the substituent is in each case (optionally differently) an aliphatic, branched or unbranched, saturated or unsaturated hydrocarbon radical with 1 to 15 C atoms, so that a bond to a further structural unit of the resol instead of a bond to hydrogen is present at one or two of the remaining positions (2, 4, 6 or ortho/para, respectively), comprising
c. formaldehyde.

Polymers, which link the phenol cores comprising at least phenol and substituted phenols (ortho and/or para-substituted) via methylene groups and/or ether bridges (—CH₂—O—CH₂—), are created in this way.

### DETAILED DESCRIPTION OF THE INVENTION

Conventional and known materials can be used as refractory molding base material (hereinafter also molding base material in short) for the production of casting molds. Suitable are, for example, quartz sand, zircon sand or chrome ore sand, olivine, vermiculite, bauxite, chamotte, as well as synthetic molding base materials, for example on the basis of mullite (sintered mullite), in particular more than 50% by weight of quartz sand based on the refractory molding base material. A molding base material is understood to be materials, which have a high melting point (melting temperature). The melting point of the refractory molding base material is preferably greater than 600° C., preferably greater than 900° C., particularly preferably greater than 1200° C., and in particular preferably greater than 1500° C. The refractory molding base material has a free-flowing state.

The molding base material preferably accounts for more than 80% by weight, in particular more than 90% by weight, particularly preferably more than 95% by weight, of the molding material mixture.

The average diameter of the refractory molding base materials usually lies between 80 μm and 600 μm, preferably between greater than 100 μm and 400 μm, and particularly preferably between 120 μm and 300 μm. The particle size can be determined, e.g., by means of sieving in accordance with DIN ISO 3310. Particle shapes with largest length expansion to smallest length expansion (at right angles to one another and in each case for all directions in space) of 1:1 to 1:5 or 1:1 to 1:3, namely those, which are not fibrous, e.g., are particularly preferred.

A special chromite sand is particularly suitable thereby, which is sold by Oregon Resources Corporation (ORC) under the name Spherichrome. In Europe, Spherichrome is sold by Possehl Erzkontor GmbH, Lübeck. Spherichrome differs from the currently known South African chrome ore sand in the grain shape. In contrast to the latter, Spherichrome has largely rounded grains. According to the preferred embodiment, Spherichrome does not necessarily account for 100% by weight of the molding base material, mixtures with other molding base materials are also possible, in particular quartz sand. The mixing ratio thereby depends on the respective strain of the casting mold. However, the latter should generally contain at least 20% by weight of Spherichrome, preferably at least 40% by weight, particularly preferably at least 60% by weight, when using quartz sand. Independently of this, the Spherichrome molding base material has particle shapes at the ratio of (average value) of largest length expansion to smallest length expansion (at right angles to one another and in each case for all directions in space) of in particular 1:1 to 1:3, particularly preferably of in particular 1:1 to 1:3.

The binder consists of an alkaline resol resin. The resol resin according to the invention is produced by means of condensation of at least phenol, ortho- or para-substituted phenol and formaldehyde in the presence of an alkaline catalyst.

According to an embodiment of the invention, the resols are present in the form of an aqueous alkaline solution, preferably with a solids content of 20 to 75% by weight and a pH value of preferably greater than 11, in particular preferably greater than 12 (measured at 25° C.).

The resol resin is advantageously used in a concentration of 0.8% by weight to 8% by weight, preferably of 1% by weight to 7% by weight, and particularly preferably of 1.5% by weight to 5% by weight, in each case based on the molding base material. The concentration of binder can thereby vary within the casting mold. In the case of thicker subregions of the mold, the binder percentage can in fact be smaller than specified above, while the binder content can go beyond the above-mentioned limit value at thin and complex sections.

Resols in terms of the present invention are aromatics, which are connected to one another via methylene groups (—CH₂—) groups and/or via ether bridges (in particular—CH₂—O—CH₂—) and which in each case bear at least one —OH group (hydroxy aromatic).

Ortho- and/or para-substituted phenol are understood to be compounds, which, based on the phenol at the ortho- and/or para-position (2,4,6), preferably an ortho-position, are substituted by at least one aliphatic, branched or unbranched, saturated or unsaturated hydrocarbon radical with 1 to 15 C atoms, in particular 1 to 4 C atoms, and have maximally two radicals/substituents. The aliphatic radical is preferably unbranched and saturated. In particular preferably, the substituted phenol is ortho- or para-cresol, further preferably ortho-cresol.

The hydrocarbon radical of the at least ortho- and/or para-substituted phenol is in particular one or several methyl groups, and the ortho- and/or para-substituted phenols are selected in particular, e.g., from the group comprising o-cresol, p-cresol, 2,4-xylenol, 2,6-xylenol, 2,3-xylenol, 2,5-xylenol, 3,4-xylenol, and the mixtures thereof, and in particular o-cresol. The ortho- and/or para-substituted phenol can additionally be meta-substituted.

In particular, more than 90 mole percent, in particular more than 95 mole percent, or all hydroxy aromatics in the resol resin are phenol and ortho- and/or para-substituted phenols or are based on such monomer structural elements, respectively.

Formaldehyde can be used in various forms—for example in the form of a formalin solution (aqueous solution of formaldehyde) or paraformaldehyde. Essentially only formaldehyde is preferably used as aldehyde.

It has surprisingly been shown that the storage or viscosity and reactivity stability of an alkaline resol resin can be increased significantly when the resol was produced at least of phenol as well as of ortho- or para-substituted phenol. A certain ratio of phenol to ortho- or para-substituted phenol is essential thereby to realize a sufficient stability level of the casting molds bound by means of the binder on the one hand, and to ensure an increased storage stability of the binder on the other hand.

The molar ratio of ortho- and/or para-substituted phenol (together) (A) to phenol (B) in the alkaline resol resin is from 1 to 1.5 (A:B) to 1 to 15 and preferably 1:2 to 1:10 and in particular preferably from 1 to 4 to 1 to 6.

The molar ratio of the hydroxy aromatics to formaldehyde can vary in the range from 1:1 to 1:3, but preferably lies between 1:1.2 to 1:2.6, particularly preferably between 1:1.3 to 1:2.5.

The hydroxy aromatics are preferably formed essentially exclusively by the phenol, the ortho-substituted phenol, the para-substituted phenol, and the ortho- and para-substituted phenol, i.e. the ortho- and/or para-substituted phenol.

Those resols are preferred as part of the alkaline resol resin, in which nearby hydroxy aromatics are in each case linked to ortho and/or para position (relative to the hydroxy group of the installed phenol/aromatic) via the methylene bridges and/or the ether bridges, i.e., the plurality of links takes place para and/or ortho.

Organic bases, such as, e.g., amines or ammonium compounds, as well as inorganic bases, such as, e.g., alkali metal hydroxides can be used as alkaline catalysts. Alkali metal hydroxides, particularly preferably sodium hydroxide and/or potassium hydroxide in the form of aqueous solutions are preferably used. Mixtures of alkaline catalysts can likewise be used.

The molar ratio of hydroxy aromatics (such as phenol, also installed) to hydroxide ions in the binder system is preferably 1:0.4 to 1:1.2 and preferably 1:0.5 to 1:1.0.

It is not necessary that the entire quantity of base is already added at the beginning of the condensation; the addition usually takes place in two or several sub-steps, whereby a portion can also be added only at the end of the production process.

The content of compounds with a molecular weight of greater than 5000 Dalton (g/mol) in the resol resin is preferably maximally 3% by weight and particularly preferably maximally 1% by weight.

The average molecular weight of the resol resin Mw (weight average) is in particular less than 1500 Dalton (g/mol), preferably less than 1400 Dalton (g/mol), and particularly preferably less than 1300 Dalton (g/mol).

The polydispersity of the resol resin D=Mw (weight average)/Mn (number average) is in particular from 1.1 to 4, preferably 1.2 to 3.5, and particularly preferably 1.5 to 3.

The specified molecular weights were determined by means of gel permeation chromatography. Due to the calibration, the above-specified molecular weights are pullulan-dextran-equivalent molecular weights. The following parameters were used:
Eluent: 0.5 M KOH
Pre-column: PSS MCX, 5 μm, Guard, ID 8.0 mm×50 mm
Column: PSS MCX, 5 μm, 500 Å, ID 8.0 mm×300 mm
Pump: PSS SECcurity 1260 HPLC Pump
Flow: 5 mL/min
Injection system: PSS SECcurity 1260 autosampler with 20 μL
Sample concentration: 1 g/l
Temperature: injection volume 35° C.
Detector: PSS SECcurity 1260 UV/VIS (254 nm)
Evaluation: PSS WinGC UniChrom Version 8.31
Calibration: pullulan-dextran molecular weight standards (Mp 180-45900 Da)

The production of resols is disclosed, e.g., in EP 0323096 B2 and EP 1228128 B1. Further resol-based binders are described, for example, in U.S. Pat. Nos. 4,426,467, 4,474,904. In three patents, the resols are cured with the help of esters, whereby the curing takes place by adding a liquid curing agent, e.g. a lactone (U.S. Pat. No. 4,426,467) or triacetin (U.S. Pat. No. 4,474,904), respectively.

In addition to the already mentioned components, the resol contains water, preferably in a quantity of 25% by weight to 75% by weight, based on the weight of the composition. On the one hand, the water can thereby originate from aqueous solutions, which are used in the binder production (in addition to the water, which is created by means of the polycondensation), but it can also be added separately to the binder on the other hand.

In addition to its function as solvent, water also serves the purpose, for example, of lending the binder an application-oriented viscosity of in particular 3 mPa·s to 100 mPa·s, preferably of 4 mPa·s to 50 mPa·s, and particularly preferably of 5 mPa·s to mPa·s. The viscosity is determined with the help of a Brookfield rotational viscosimeter, small sample, spindle No. 21 at 100 Rpm and 25° C.

The binder can furthermore contain up to approx. 50% by weight of additives, such as, e.g., alcohols, glycols, surfactants, and silanes. With the help of these additives, the wettability of the molding material can be increased, for example, by the binder and the adhesion thereof on the molding material, which, in turn, can lead to improved stabilities and an increased moisture resistance. In this regard, an addition of silanes, e.g. gamma-aminopropyltriethoxysilane or gamma-glycidoxypropyltrimethoxysilane, in concentrations of 0.1% by weight to 1.5% by weight, preferably of 0.2% by weight to 1.3% by weight, and particularly preferably of 0.2% by weight to 1.0% by weight, in each case based on the weight of the composition, has a particularly positive effect.

The esters, which are suitable for curing the resols (hereinafter also referred to as curing agents) are known to the person of skill in the art, e.g., from U.S. Pat. Nos. 4,426,467, 4,474,904 and 5,405,881. They comprise, among others, lactones, organic carbonates, and esters of C1- to C10 mono- and polycarboxylic acids with C1 to C10 mono- and polyalcohols.

Gamma-butyrolactone, propylene carbonate, ethylene glycol diacetate, mono-, di-, and triacetin as well as the dimethyl esters of succinic acid, glutaric acid and adipic acid, including the mixtures thereof known under the name DBE, are preferred examples of these esters or curing agents, respectively. Due to different alkaline hydrolysis speed of the individual esters, the curing speed of the resols runs at different speeds, depending on the used ester, which can also influence the stabilities. By mixing two or several esters, the desired curing time can be varied within wide limits.

An option for the modification of the ester components lies in the addition of benzyl ester resins according to U.S. Pat. No. 4,988,745, of epoxy compounds according to U.S. Pat. No. 5,405,881 and/or of polyphenolic resins according to U.S. Pat. No. 5,424,376, in each case in quantities of up to approx. 40% by weight, based on the ester component.

The ester component can additionally contain up to approx. 50% by weight of further components, such as, e.g., the alcohols, glycols, surfactants, and silanes, which have already been mentioned among the binders.

The addition quantity of curing agent is usually 5% by weight to 50% by weight, preferably 5% by weight to 40% by weight, and particularly preferably 5% by weight to 30% by weight, in each case based on the quantity of binder, or is used in a concentration of 0.04% by weight to 4.0% by weight, preferably from 0.05% by weight to 3.5% by weight, and particularly preferably from 0.08% by weight to 2.5% by weight, in each case based on the molding base material.

According to a further embodiment, the molding material mixtures can contain a portion of an amorphous SiO₂. It is in particular particulate amorphous SiO₂. Synthetically produced particulate amorphous silicon dioxide is particularly preferred.

The amorphous SiO₂ can in particular be the following types:
a) amorphous SiO₂ obtained by means of precipitation from an alkali silicate solution
b) amorphous SiO₂ obtained by means of flame hydrolysis of SiCl₄
c) amorphous SiO₂ obtained by means of reduction of quartz sand with coke or anthracite to silicon monoxide with subsequent oxidation to SiO₂
d) amorphous SiO₂ obtained from the process of the thermal decomposition of ZrSiO₄ to ZrO₂ and SiO₂
e) amorphous SiO₂ obtained by means of oxidation of metallic Si by means of an oxygen-containing gas
f) amorphous SiO₂ obtained by means of melting of crystalline quartz with subsequent rapid cool-down
c) includes processes, in the case of which the amorphous SiO₂ is produced specifically as main product, as well as those, in the case of which it is produced as a by-product, such as, e.g., in the production of silicon or ferrosilicon.

Synthetically produced as well as naturally occurring silica can be used as amorphous SiO₂. The latter are known, e.g., from DE 102007045649, but are not preferred because they generally contain significant crystalline portions and are thus classified as being carcinogenic.

Synthetic is understood to be not naturally occurring amorphous SiO₂, i.e. the production of which comprises an intentionally performed chemical reaction, as it is initiated by a human, e.g. the production of silica sols by means of ion exchange processes from alkali silicate solutions, the precipitation from alkali silicate solutions, the flame hydrolysis of silicon tetrachloride, the reduction of quartz sand with coke in the electric arc furnace during the production of ferrosilicon and silicon. The amorphous SiO₂ produced according to the two last-mentioned methods is also referred to as pyrogenic SiO₂.

Synthetic amorphous silicon dioxide is sometimes only understood to be precipitated silica (CAS No. 112926-00-8) and flame hydrolytically produced SiO₂ (pyrogenic silica, fumed silica, CAS No. 112945-52-5), while the product produced during the ferrosilicon or silicon production, respectively, is simply referred to as amorphous silicon dioxide (silica fume, microsilica, CAS No. 69012-64-12). For the purposes of the present invention, the product produced during the ferrosilicon or silicon production, respectively, is also understood to be amorphous SiO₂.

Precipitated silica and pyrogenic, i.e., silicon dioxide produced flame hydrolytically or in the electric arc, are preferably used. Amorphous silicon dioxide produced by means of thermal decomposition of ZrSiO₄ (described in DE 102012020509) as well as SiO₂ produced by means of oxidation of metallic Si by means of an oxygen-containing gas (described in DE 102012020510) are used in particular preferably. Quartz glass powder (mainly amorphous silicon dioxide), which was produced by means of melting and rapid re-cooling from crystalline quartz, is also preferred, so that the particles are present in a spherical shape and not in a splintered manner (described in DE 102012020511).

The average primary particle size of the particulate amorphous silicon dioxide can be between 0.05 □m and 10 □m, in particular between 0.1 □m and 5 □m, particularly preferably between 0.1 □m and 2 □m. The primary particle size can be determined, e.g., with the help of dynamic light scattering (e.g. Horiba LA 950) as well as verified by means of scanning electron microscope images (SEM images by means of, e.g., Nova NanoSEM 230 by FEI).

With the help of the SEM images, details of the primary particle form up to the magnitude of 0.01 □m can furthermore be made visible. The silicon dioxide samples were dispersed in distilled water for the SEM measurements and were subsequently applied to an aluminum holder, onto which a copper strip is applied, before the water was evaporated.

The specific surface of the particulate amorphous silicon dioxide was furthermore determined with the help of gas adsorption measurements (BET method) according to DIN 66131. The specific surface of the particulate amorphous SiO₂ lies between 1 and 200 m²/g, in particular between 1 and 50 m²/g, particularly preferably less than 17 m²/g or even less than 15 m²/g. The products can optionally also be mixed, e.g. in order to specifically obtain mixtures with certain particle size distributions.

The particulate amorphous SiO₂ can contain different quantities of by-products. The following are mentioned here in an exemplary manner:
carbon in the case of the reduction of quartz sand with coke or anthracite
iron oxides and/or Si in the case of the production of silicon or ferrosilicon
ZrO₂ in the case of the thermal decomposition of ZrSiO₄ to ZrO₂ and SiO₂ Further by-products can be, e.g., Al₂O₃, P₂O₅, HfO₂, TiO₂, CaO, Na₂O, and K₂O.

The quantity of amorphous SiO₂, which is added to the molding material mixture according to the invention, usually lies between 0.05% by weight and 3% by weight, preferably between 0.1% by weight and 2.5% by weight, and particularly preferably between 0.1% by weight and 2% by weight, in each case based on the molding base material.

The addition of the amorphous SiO₂ to the molding base material can take place in the form of an aqueous paste, as suspension in water, or as dry powder. The latter is preferred thereby. The particulate amorphous SiO₂ is preferably used as powder (including dusts). The particulate amorphous silicon dioxide preferably used according to the present invention has a water content of less than 15% by weight, in particular less than 5% by weight, and particularly preferably of less than 1% by weight.

The amorphous SiO₂ is preferably present in a particulate matter. The particle size of the particulate amorphous silicon dioxide is preferably less than 300 μm, preferably less than 200 μm, in particular preferably less than 100 μm, and has, e.g., an average primary particle size of between 0.05 μm and 10 μm (primary particle size determined by means of dynamic light scattering).

The sieve residue of the particulate amorphous SiO₂ when passing through a sieve with a mesh width of 125 μm (120 mesh) is preferably not more than 10% by weight, particularly preferably not more than 5% by weight, and most preferably not more than 2% by weight. Independently of this, the sieve residue on a sieve with a mesh width of 63 μm is less than 10% by weight, preferably less than 8% by weight. The determination of the sieve residue thereby takes place according to the machine sieving method described in DIN 66165 (Part 2), wherein a chain ring is additionally used as sieving aid.

The order of the addition of the amorphous SiO₂ to the binder and/or to the molding base material is irrelevant. It can take place before as well as after or together with the binder. Preferably, the addition of the amorphous SiO₂ takes place first, and then the binder addition.

In addition, further additives, which are common in the casting industry, such as, e.g., ground wood fibers or mineral additives, such as iron oxide, etc., can optionally be mixed in with the molding base material, wherein the percentage thereof is usually 0% by weight to 6% by weight, preferably 0% by weight to 5% by weight, and particularly preferably 0% by weight to 4% by weight, based on the molding base material.

The invention relates to a method for producing a casting mold or a core (or generally body) comprising the steps of
a) mixing the refractory molding base material with the ester component and optionally with the inorganic additive as well as optionally the further additives to obtain a molding material mixture,
b) spreading a thin layer with a layer thickness of 1 to approx. 6, preferably 1 to approx. 5, and particularly preferably 1 to 3 grains of the molding material mixture produced in a) on a defined work surface,
c) selective imprinting of the thin layer of the molding material mixture with the binder at the locations specified by the CAD data, wherein the binder at least partially cures due to the contact with the ester,
d) multiple repetition of steps b) and c) until the completion of the casting mold,
e1) post-curing the at least partially cured casting mold in a furnace or by means of microwave without prior removal of the unbound molding material mixture, or alternatively to e1)
e2) removing the unbound molding material mixture from the at least partially cured casting mold.

As soon as the stabilities allow it, the unbound molding material mixture can be removed from the casting mold, following step e1), and said casting mold can be supplied to the further treatment, e.g. the preparation for the metal casting.

Following step e2), the casting mold can be post-cured, if necessary, by means of conventional measures, such as the storage at increased temperatures or by means of microwaves. As soon as the stabilities permit it, the casting mold can be supplied to the further treatment, e.g. the preparation for the metal casting.

In the case of both alternatives, the unbound molding material mixture can be supplied to a further casting mold after the removal from the at least partially cured casting mold.

The invention will be described in more detail on the basis of the following examples, without being limited to them.

Alkaline resol resins with different contents of phenol and o-cresol were produced initially. To more clearly emphasize the influence on stability, storage stability, and reactivity, the alkaline resol resins were set in the viscosity range of 40-60 mPa·s. For the use in the Rapid Prototyping (3D printing), the resols can be set to a use viscosity of 5 to 20 mPa·s by means of suitable solvents, e.g. ethanol and water.

The influence of the percentages of o-cresol in the resols was subsequently tested with regard to the stabilities on the basis of conventional test bodies, the so-called Georg-Fischer test bars.

The influence of the percentages of o-cresol in the resols on the storage stability and reactivity was examined with regard to storage cycles on the basis of viscosity measurements and gel time determinations.

### Test Examples

### 1. Production of the Resol Resins

The resin 1 contained only phenol as hydroxy aromatic monomer structural element. The resins 2-6 contained 12-51% by weight of o-cresol, based on the total quantity of phenol and o-cresol.

### Example 1—Resin 1

| | | | |
|---|---|---|---|
| 1 | phenol (99% by weight) | 406.40 | g |
| 2 | water | 163.20 | g |
| 3 | aqueous formaldehyde solution (37% by | 676.80 | g |
| | weight) with 8% by weight of methanol | | |
| 4 | aqueous potassium hydroxide solution | 108.80 | g |
| | (50% by weight) | | |
| 5 | aqueous sodium hydroxide solution | 240.00 | g |
| | (33% by weight) | | |
| 6 | gamma-glycidoxypropyltrimethoxysilane | 4.80 | g |

Manufacturing specification:
The raw materials 1, 2, and 3 were loaded into a laboratory reactor reflux condenser, thermometer, dropping funnel, and stirrer,
the stirrer was started and further stirring occurred during the following process steps,
the preparation was heated to 75° C.,
raw material 4 was loaded continuously at 75° C.,
the preparation was heated to 85° C. and was held for 2 hours,
the preparation was cooled to 70° C. and was held for 1.5 hours,
raw material 5 was loaded continuously at a temperature of less than 30° C.,
raw material 6 was loaded and was homogenized for 15 min.

The resin was obtained as clear solution and had a viscosity (Brookfield rotational viscosimeter, small sample, spindle No. 21 at 100 Rpm and 25° C.) of 49 mPa·s.

### Example 2—Resin 2

| | | | |
|---|---|---|---|
| 1 | phenol (99% by weight) | 320.00 | g |
| 2 | o-cresol (99% by weight) | 80.00 | g |
| 3 | water | 160.00 | g |
| 4 | aqueous formaldehyde solution (37% by | 640.00 | g |
| | weight) with 8% by weight of methanol | | |
| 5 | potassium hydroxide solution | 108.80 | G |
| | (50% by weight) | | |
| 6 | sodium hydroxide solution (33% by weight) | 240.00 | G |
| 7 | gamma-glycidoxypropyltrimethoxysilane | 4.80 | G |

Manufacturing specification:
The raw material 1, 2, 3, and 4 were loaded into a laboratory reactor reflux condenser, thermometer, dropping funnel, and stirrer,
the stirrer was started and further stirring occurred during the following process steps,
the preparation was heated to 75° C.,
raw material 5 was loaded continuously at 75° C.,
the preparation was heated to 85° C. and was held for 1.75 hours,
the preparation was cooled to 70° C. and was held for 2 hours,
raw material 6 was loaded continuously at a temperature of less than 30° C.,
raw material 7 was loaded and was homogenized for 15 min.

The resin was obtained as clear solution and had a viscosity (Brookfield rotational viscosimeter, small sample, spindle No. 21 at 100 Rpm and 25° C.) of 47 mPa·s.

### Example 3—Resin 3

| | | | |
|---|---|---|---|
| 1 | phenol (99% by weight) | 352.00 | g |
| 2 | o-cresol (99% by weight) | 48.00 | g |
| 3 | Water | 160.00 | g |
| 4 | aqueous formaldehyde solution (37% by | 640.00 | g |
| | weight) with 8% by weight of methanol | | |
| 5 | potassium hydroxide solution | 108.80 | g |
| | (50% by weight) | | |
| 6 | sodium hydroxide solution (33% by weight) | 240.00 | g |
| 7 | gamma-glycidoxypropyltrimethoxysilane | 4.80 | g |

Manufacturing specification:
The raw materials 1, 2, 3, and 4 were loaded into a laboratory reactor reflux condenser, thermometer, dropping funnel, and stirrer,
the stirrer was started and further stirring occurred during the following process steps,
the preparation was heated to 75° C.,
raw material 5 was loaded continuously at 75° C.,
the preparation was heated to 85° C. and was held for 1.5 hours,
the preparation was cooled to 70° C. and raw material 6 was loaded continuously,
the preparation was heated to 80° C. and was held for 1 hour,
the preparation was cooled to a temperature of less than 30° C., and
raw material 7 was loaded and was homogenized for 15 min.

The resin was obtained as clear solution and had a viscosity (Brookfield rotational viscosimeter, small sample, spindle No. 21 at 100 Rpm and 25° C.) of 51 mPa·s.

### Example 4—Resin 4

| | | | |
|---|---|---|---|
| 1 | phenol (99% by weight) | 320.00 | g |
| 2 | o-cresol (99% by weight) | 80.00 | g |
| 3 | water | 160.00 | g |
| 4 | aqueous formaldehyde solution (37% by | 640.00 | g |
| | weight) with 8% by weight of methanol | | |
| 5 | potassium hydroxide solution | 108.80 | g |
| | (50% by weight) | | |
| 6 | sodium hydroxide solution (33% by weight) | 240.00 | g |
| 7 | gamma-glycidoxypropyltrimethoxysilane | 4.80 | g |

Manufacturing specification:
The raw materials 1, 2, 3, and 4 were loaded into a laboratory reactor reflux condenser, thermometer, dropping funnel, and stirrer,
the stirrer was started and further stirring occurred during the following process steps,
the preparation was heated to 75° C.,
raw material 5 was loaded continuously at 75° C.,
the preparation was heated to 85° C. and was held for 1.75 hours,
the preparation was cooled to 70° C. and raw material 6 was loaded continuously,
the preparation was heated to 80° C. and was held for 1.5 hours,
the preparation was cooled to a temperature of less than 30° C., and
raw material 7 was loaded and was homogenized for 15 min.

The resin was obtained as clear solution and had a viscosity (Brookfield rotational viscosimeter, small sample, spindle No. 21 at 100 Rpm and 25° C.) of 51 mPa·s.

### Example 5—Resin 5

| | | | |
|---|---|---|---|
| 1 | phenol (99% by weight) | 272.00 | g |
| 2 | o-cresol (99% by weight) | 128.00 | g |
| 3 | Water | 160.00 | g |
| 4 | aqueous formaldehyde solution (37% by | 640.00 | g |
| | weight) with 8% by weight of methanol | | |
| 5 | potassium hydroxide solution | 108.80 | g |
| | (50% by weight) | | |
| 6 | sodium hydroxide solution (33% by weight) | 240.00 | g |
| 7 | gamma-glycidoxypropyltrimethoxysilane | 4.80 | g |

Manufacturing specification:
The raw materials 1, 2, 3, and 4 were loaded into a laboratory reactor reflux condenser, thermometer, dropping funnel, and stirrer,
the stirrer was started and further stirring occurred during the following process steps,
the preparation was heated to 75° C.,
raw material 5 was loaded continuously at 75° C.,
the preparation was heated to 85° C. and was held for 1.25 hours,
the preparation was cooled to 70° C. and raw material 6 was loaded continuously,
the preparation was heated to 80° C. and was held for 1 hour,
the preparation was cooled to a temperature of less than 30° C., and
raw material 7 was loaded and was homogenized for 15 min.

The resin was obtained as clear solution and had a viscosity (Brookfield rotational viscosimeter, small sample, spindle No. 21 at 100 Rpm and 25° C.) of 51 mPa·s.

### Example 6—Resin 6

| | | | |
|---|---|---|---|
| 1 | phenol (99% by weight) | 205.00 | g |
| 2 | o-cresol (99% by weight) | 210.00 | g |
| 3 | Water | 145.00 | g |
| 4 | aqueous formaldehyde solution (37% by | 640.00 | g |
| | weight) with 8% by weight of methanol | | |
| 5 | potassium hydroxide solution | 108.80 | g |
| | (50% by weight) | | |
| 6 | sodium hydroxide solution (33% by weight) | 240.00 | g |
| 7 | gamma-glycidoxypropyltrimethoxysilane | 4.80 | g |

Manufacturing specification:
The raw materials 1, 2, 3, and 4 were loaded into a laboratory reactor reflux condenser, thermometer, dropping funnel, and stirrer,
the stirrer was started and further stirring occurred during the following process steps,
the preparation was heated to 75° C.,
raw material 5 was loaded continuously at 75° C.,
the preparation was heated to 85° C. and was held for 1.25 hours,
the preparation was cooled to 70° C. and raw material 6 was loaded continuously,
the preparation was heated to 80° C. and was held for 0.5 hour,
the preparation was cooled to a temperature of less than 30° C., and
raw material 7 was loaded and was homogenized for 15 min.

The resin was obtained as clear solution and had a viscosity (Brookfield rotational viscosimeter, small sample, spindle No. 21 at 100 Rpm and 25° C.) of 51 mPa·s.

### 2. Production of the Test Body

### 2.1 Production of the Molding Material Mixture

The molding material was filled into the bowl of a mixer by Beba (model L7). By stirring, the curing agent was subsequently added first, and then the binder, and were in each case mixed intensively with the molding base material for 1 minute.

The type of the molding base material, of the curing agent, and of the binder, as well as the respective quantities added are listed in Tab. 1.

TABLE 1

| | Molding | Curing | |
|---|---|---|---|
| | material (a) | agent (b) | Binder |
| Mixture | [GT] (c) | [GT] | [GT] |
| 1 | 100 | 0.35 | 1.50 resin 1 |
| 2 | 100 | 0.35 | 1.50 resin 2 |
| 3 | 100 | 0.35 | 1.50 resin 3 |
| 4 | 100 | 0.35 | 1.50 resin 4 |
| 5 | 100 | 0.35 | 1.50 resin 5 |
| 6 | 100 | 0.35 | 1.50 resin 6 |

(a) H32; quartz sand Haltern Quarzwerke/
(b) catalyst 5090 (ASK Chemicals GmbH) triacetin/
(c) GT = parts by weight

### 2.2 Production of Test Bars

Cuboid-shaped test bars with the dimensions 172 mm×22.36 mm×22.36 mm were produced for testing the bodies (so-called Georg-Fischer bars). A portion of the mixtures produced according to 2.1 was introduced into a molding tool 12 with engravings, compacted by means of vibration on a vibrating table (Morek, Multiserw type LUZ-2e), and removed from the molding tool after the demolding time ended.

The processing time (VZ), i.e. the time, within which a mixture can be compacted without any problems, was determined visually. The exceeding of the processing time can be recognized in that a mixture no longer flows freely, but rolls off in a clod-like manner. The processing times of the individual mixtures are specified in Tab. 2.

To determine the demolding time (AZ), i.e., the time, after which a mixture has solidified to the extent that it can be removed from the molding tool, a second portion of the respective mixture was filled by hand into a round mold of a height of 100 mm and a diameter of 100 mm, and was compacted by means of a hand plate.

The surface hardness of the compacted mixture was subsequently tested in certain time intervals by means of the Green Hardness “B” Scale—surface hardness tester by Dietert (model 473). As soon as a mixture is so hard that the scale displays a value of >/=95, the demolding time is reached. The demolding times of the individual mixtures are specified in Tab. 2.

### 3. Testing the Bending Strengths

To determine the bending strengths, the test bars were inserted into a stability test device (Jung Instruments GmbH, type SJ1), equipped with a 3-point bending device, and the force was measured, which led to the breakage of the test bar. The bending strengths were determined according to the following scheme:
1 hour after the molding
2 hours after the molding
4 hours after the molding
24 hours after the molding

The results are listed in Tab. 2.

TABLE 2

| | VZ (a) | AZ (b) | Bending strengths [N/cm²] | | | |
|---|---|---|---|---|---|---|
| Mixture | [min] | [min] | 1 h | 2 h | 4 h | 24 h |
| 1 | 7 | 24 | 72 | 121 | 178 | 230 |
| 2 | 6 | 22 | 76 | 129 | 192 | 302 |
| 3 | 8 | 23 | 83 | 134 | 202 | 261 |
| 4 | 7 | 17 | 88 | 131 | 206 | 251 |
| 5 | 5 | 21 | 92 | 149 | 196 | 261 |
| 6 | 6 | 30 | 56 | 87 | 126 | 217 |

(a) processing time
(b) demolding time

### 4. Testing the Storage Stability

To assess the storage stability, the resol resins 1 to 5 described under 1 were stored at room temperature. The viscosity and the gel time were tested directly after the production and at fixed intervals after storage. The resol resin 6 was classified as being disadvantageous due to its longer demolding time and low bending strengths, determined according to point 3, and was not further analyzed.

### 4.1 Testing the Viscosity

The viscosity of the resol resins was determined by means of a Brookfield rotational viscosimeter, small sample, spindle No. 21 at 100 Rpm and 25° C.

The results are listed in Tab. 3.

TABLE 3

| | Viscosity [mPa · s] after storage | | | | | |
|---|---|---|---|---|---|---|
| Resol | 0 | 16 | 48 | 72 | 98 | 202 |
| resin | days | days | days | days | days | days |
| resin 1 | 49.0 | 52.7 | 60.0 | 69.0 | 79.5 | 178.0 |
| resin 2 | 47.0 | 50.5 | 57.0 | 63.0 | 70.5 | 130.0 |
| resin 3 | 51.0 | 56.2 | 62.0 | 69.5 | 79.5 | 153.0 |
| resin 4 | 51.0 | 53.7 | 61.0 | 66.5 | 75.5 | 141.0 |
| resin 5 | 51.0 | 53.9 | 61.0 | 68.5 | 74.0 | 142.0 |

### 4.2 Testing the Gel Time

The gel time of the resol resins was determined by means of a Gelnorm Geltimer by Gel Instrumente AG (type Geltimer-m and ST 1) at 25° C. For this purpose, 18 g of resol resin and 2 g of catalyst 5090 (ASK Chemicals GmbH) triacetin were in each case mixed in a test tube, and the time until the curing of the mixture was determined by means of the gel timer.

The results are listed in Tab. 4.

TABLE 4

| | Gel time [min:sec] after storage | | | | | |
|---|---|---|---|---|---|---|
| Resol | 0 | 16 | 48 | 72 | 98 | 202 |
| resin | days | days | days | days | days | days |
| Resin 1 | 16:33 | 15:34 | 12:04 | 10:59 | 10:05 | 04:54 |
| Resin 2 | 19:24 | 16:40 | 13:54 | 12:18 | 11:05 | 07:35 |
| Resin 3 | 17:27 | 16:19 | 12:34 | 11:44 | 11:16 | 07:20 |
| Resin 4 | 20:43 | 15:12 | 13:18 | 11:59 | 10:41 | 07:55 |
| Resin 5 | 16:38 | 16:18 | 13:25 | 12:24 | 11:35 | 07:10 |

### 5. Evaluation

It can be seen from Tables 2 to 4:
the molding material mixtures produced from resol resins 2-5, which are produced with o-cresol, displayed comparable and thus advantageous processing and demolding times such as a molding material mixture produced from the comparative resol resin 1 without o-cresol,
test bars, which were produced by means of resol resins 2-5, containing o-cresol and phenol, displayed comparable or higher stabilities than test bars produced from the comparative resol resin 1 without o-cresol.
The molding material mixtures produced from the resol resin 6 with a large quantity of o-cresol displayed a slower demolding time. The test bars produced from this molding material mixture displayed lower stabilities. The resol resin 6 is less suitable for the use.
The resol resins 2-5 produced with o-cresol displayed a lower viscosity increase in particular after storage and a longer gel time than a comparative resol resin 1 produced without o-cresol.

1. A method for the layered construction of a body comprising at least the following steps:
a) bringing together at least one refractory molding base material and at least one ester to obtain a molding material mixture that is impregnated with ester,
b) spreading a thin layer with a layer thickness of 1 to 6 grains of the molding material mixture,
c) imprinting selected regions of the thin layer with a binder comprising an alkaline resol resin for curing the regions,
d) multiple repetition of the steps b) and c) for the completion of an at least partially cured three-dimensional body,
wherein the alkaline resol resin can be obtained from the conversion of formaldehyde with at least phenol and at least ortho- and/or para-substituted phenol, wherein the substituent is an aliphatic, branched or unbranched, saturated or unsaturated hydrocarbon radical with 1 to 15 carbon atoms, and the molar ratio of ortho- and/or para-substituted phenols (A) to phenol (B) is from 1:greater than 2 to 1:15 (A:B) and
wherein the binder has a viscosity of 3 mPa·s to 100 mPa·s, as determined with a Brookfield rotational viscosimeter, spindle No. 21 at 100 rpm and 25° C.

2. The method according to claim 1, wherein the molar ratio of at least ortho- and/or para-substituted phenol (A) to phenol (B) is 1:greater than 2 to 1:10.

3. The method according to claim 1, wherein the hydrocarbon radical of the at least ortho- and/or para-substituted phenol is one or several methyl groups, and the ortho- and/or para-substituted phenols are selected from the group comprising o-cresol, p-cresol, 2,4-xylenol, 2,6-xylenol, 2,3-xylenol, 2,5-xylenol, 3,4-xylenol, and the mixtures thereof.

4. The method according to claim 1, further comprising the step of:
e1) removing any unbound molding material mixture from the at least partially cured three-dimensional body, and optionally the step of:
e2) post-curing the partially cured three-dimensional body in a furnace or by means of microwaves, wherein the steps are performed in the order e1-e2 or e2-e1.

5. The method according to claim 1, wherein the refractory molding base material is selected from the group consisting of: quartz sand, zircon sand, chrome ore sand, olivine, vermiculite, bauxite, chamotte, glass beads, glass granulate, aluminum silicate hollow microbeads, synthetic molding base materials on the basis of mullite and the mixtures thereof.

6. The method according to claim 1, wherein the refractory molding base material amounts to more than 80% by weight of the molding material mixture.

7. The method according to claim 1, wherein the refractory molding base material has, as determined by sieve analysis, an average particle diameter of from 80 μm to 600 μm.

8. The method according to claim 1, further comprising the step of adding amorphous silicon dioxide, wherein, as determined by BET, the amorphous silicon dioxide has a surface area that is between 1 and 200 m²/g.

9. The method according to claim 1, wherein, of the hydroxy aromatics in the alkaline resol resin, more than 90 mol. % are phenol and ortho- and/or para-substituted phenols or are based on such monomer structural elements, respectively.

10. The method according to claim 1, wherein, based on the weight of the refractory molding base material, the alkaline resol resin amounts to 0.8 to 8% by weight.

11. The method according to claim 1, wherein the body is retroactively cured with carbon dioxide.

12. The method according to claim 1, wherein the molding material mixture further comprises alkali hydroxides.

13. The method according to claim 1, wherein the alkaline resol resin is used in the form of an aqueous alkaline solution.

14. The method according to claim 1, wherein the ester is an ester or phosphate ester compound that can be subjected to alkaline hydrolysis.

15. The method according to claim 1, wherein the ester is selected from: lactones, organic carbonates, and esters of C1- to C10 mono- and polycarboxylic acids with C1 to C10 mono- and polyalcohols, dimethyl esters of succinic acid, glutaric acid and adipic acid, including the mixtures thereof.

16. The method according to claim 1, wherein the ester used meets at least one of the following conditions:
a) based on the binder, in a quantity of from 5 wt. % to 50 wt. %, and
b) based on the molding base material, in a quantity of from 0.04 wt. % to 4.0 wt. %.

17. The method according to claim 1, wherein the body is a mold or a core for casting a metal object.

18. The method according to claim 1, wherein the step of imprinting is achieved by a printing head having a plurality of jets.

19. The method according to claim 18, wherein the printing head can be moved at least in one plane controlled by a computer, and the jets apply the liquid binder layer by layer.

20. The method according to claim 18, wherein the printing head is a drop-on-demand printing head comprising bubble jet or piezo technology.
